(19) United States
(12) Patent Application Publication
(10) Pub. No.: US 2019/0347829 A1
(43) Pub. Date: Nov. 14, 2019

(54) IN-VEHICLE CAMERA

(71) Applicant: Panasonic Intellectual Property Management Co., Ltd., Osaka (JP)

(72) Inventors: MASAYOSHI MICHIGUCHI, Kanagawa (JP); TERUO SAKAMOTO, Tokyo (JP); YASUNORI SHIGA, Kanagawa (JP)

(21) Appl. No.: 16/519,047

(22) Filed: Jul. 23, 2019

Related U.S. Application Data
(63) Continuation of application No. PCT/JP2018/002395, filed on Jan. 26, 2018.

(30) Foreign Application Priority Data
Jan. 31, 2017 (JP) 2017-016017
Nov. 22, 2017 (JP) 2017-225166

(51) Int. Cl. G06T 7/80; B60R 11/04; G06K 9/00

(52) U.S. Cl. CPC G06T 7/80; B60R 11/04; G06K 9/00832; G06T 2207/30252; G06T 2207/30204; G06T 2207/30268; G06K 9/00791

(57) ABSTRACT

An in-vehicle camera installed in a vehicle includes an imaging circuit, a detector circuit, and a calibrator circuit. The imaging circuit generates image data. The detector circuit stores predetermined first instruction information and detects whether the image data generated by the imaging circuit includes the first instruction information. When the detector circuit detects that the image data includes the first instruction information, the calibrator circuit starts a calibration process of the in-vehicle camera.

### CROSS-REFERENCE TO RELATED APPLICATIONS

This application is a U.S. national stage application of the PCT International Application No. PCT/JP2018/002395 filed on Jan. 26, 2018, which claims the benefit of foreign priority of Japanese patent application No. 2017-016017 filed on Jan. 31, 2017 and Japanese patent application No. 2017-225166 filed on Nov. 22, 2017, the contents all of which are incorporated herein by reference.

### BACKGROUND

### 1. Technical Field

The present disclosure relates to an in-vehicle camera.

### 2. Description of the Related Art

For driving assistance during parking, an in-vehicle camera is known. The in-vehicle camera captures the rear of a vehicle and displays the captured image on a display device in the vehicle. A method of absorbing the in-vehicle camera installation error is proposed as a calibration method of such an in-vehicle camera. In this method, an in-vehicle camera captures an index serving as a reference marker, and uses the index in the captured image (for example, see Unexamined Japanese Patent Publication No. 2011-155687).

### SUMMARY

A calibration device that configures an in-vehicle camera in Unexamined Japanese Patent Publication No. 2011-155687 automatically calibrates the in-vehicle camera by activating a camera calibration program of the in-vehicle camera. The calibration is triggered by a touch operation of a user on a connected display device. After calibration of the in-vehicle camera is completed, the calibration device terminates the camera calibration program and returns to the normal mode. This termination of the program is triggered by the touch operation of the user on the display device. The in-vehicle camera described in Unexamined Japanese Patent Publication No. 2011-155687 starts the calibration process in response to an instruction from the display device. Therefore, it is necessary to provide the in-vehicle camera with a reception unit that receives instructions from the display device. In addition, it is necessary to provide a different reception unit for each display device specification. This causes a cost increase of the in-vehicle camera.

The present disclosure provides a technology to reduce the cost of the in-vehicle camera by starting the calibration of the in-vehicle camera with a simple configuration.

The in-vehicle camera according to an aspect of the present disclosure is installed in a vehicle. This in-vehicle camera includes an imaging circuit, a detector circuit, and a calibrator circuit. The imaging circuit generates image data. The detector circuit stores predetermined first instruction information and detects whether the image data generated by the imaging circuit includes the first instruction information. When the detector circuit detects that the image data includes the first instruction information, the calibrator circuit starts a calibration process of the in-vehicle camera.

Note that any combination of the above components and expressions in the present disclosure can be converted to a method, a computer program, a recording medium that stores the computer program, a vehicle equipped with this device, and the like, and all of them are effective as an aspect of the present disclosure.

According to the present disclosure, the cost of the in-vehicle camera can be reduced.

### BRIEF DESCRIPTION OF DRAWINGS

FIG. 1 is a diagram schematically illustrating a vehicle equipped with a camera according to a first exemplary embodiment of the present disclosure.

FIG. 2 is a block diagram illustrating a functional configuration of the camera illustrated in FIG. 1.

FIG. 3 is a block diagram illustrating a functional configuration of a driving assistance device illustrated in FIG. 1.

FIG. 4 is a flowchart illustrating an operation of the camera illustrated in FIG. 2.

FIG. 5 is a view schematically illustrating a vehicle equipped with a camera according to a fourth exemplary embodiment of the present disclosure.

FIG. 6 is a view illustrating an example of a cabin interior image generated by the camera illustrated in FIG. 5.

FIG. 7 is a flowchart showing a behavior of a camera of a fifth exemplary embodiment of the present disclosure.

### DETAILED DESCRIPTION OF PREFERRED EMBODIMENTS

Hereinafter, various exemplary embodiments of the present disclosure will be described with reference to the drawings. Note that in each of the exemplary embodiments, the same components as those of the preceding exemplary embodiments are denoted by the same reference numerals, and the detailed description may be omitted.

### First Exemplary Embodiment

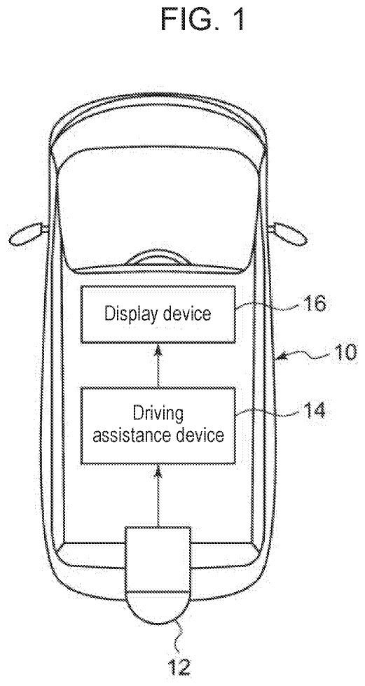

FIG. 1 is a view schematically illustrating vehicle 10 according to a first exemplary embodiment of the present disclosure, which is a view of vehicle 10 viewed from above. Vehicle 10 includes camera 12, driving assistance device 14, and display device 16. These devices may be connected via known adapters and/or in-vehicle networks.

Camera 12 is mounted on vehicle 10 and is an in-vehicle camera that repeatedly captures images of surroundings of vehicle 10. Camera 12 is attached to a back door or the like at the rear of vehicle 10, and repeatedly generates exterior images showing a view of a rear space of vehicle 10. Camera 12 may be installed near an upper end of a rear glass. In this case, for example, an optical axis of camera 12 extends rearward and obliquely downward of vehicle 10. As described later, camera 12 has a function of calibrating camera 12 itself automatically and autonomously.

Driving assistance device 14 generates driving assistance information for supporting the driving of vehicle 10 based on image data output from camera 12. As an example, in this exemplary embodiment, driving assistance device 14 generates parking assistance information. Display device 16 is a Human Machine Interface (HMI) device that presents various pieces of information to a driver. Display device 16 may be a car navigation device or an In-Vehicle Infotainment (IVI) device. Display device 16 displays parking assistance information on the monitor. The parking assistance information is driving assistance information generated by driving assistance device 14. Note that display device 16 may be a display device provided outside vehicle 10, and may be connected to vehicle 10 via, for example, an On Board Diagnostics (OBD) adapter.

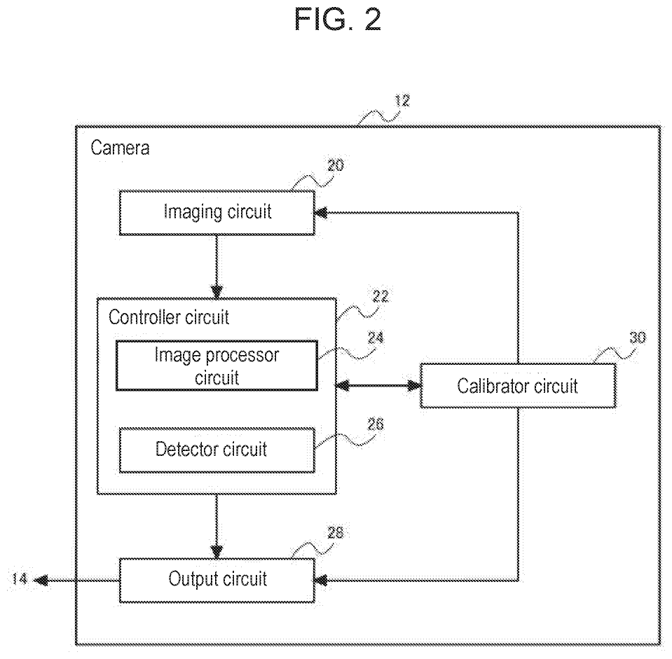

FIG. 2 is a block diagram illustrating a functional configuration of camera 12. Camera 12 has imaging circuit 20, controller circuit 22, output circuit 28, and calibrator circuit 30. Controller circuit 22 includes image processor circuit 24 and detector circuit 26. Note that camera 12 has a normal mode that outputs image data based on the exterior images and a calibration mode that executes an automatic calibration process of the own device, as an operating condition.

Each block in FIG. 2 can be realized, in terms of hardware, by an element such as a Central Processing Unit (CPU)/memory of a computer or a mechanical device, and in terms of software, by a computer program or the like. FIG. 2 illustrates functional blocks realized by the cooperation of these components. These functional blocks can be realized in various forms by a combination of hardware and software. For example, a computer program including a module corresponding to each block in FIG. 2 may be stored in the memory of camera 12. The CPU of camera 12 may exhibit the function of each block by reading and executing the computer program as appropriate. Camera 12 may also have a calibration Electronic Control Unit (ECU) that executes an automatic calibration process.

Imaging circuit 20 captures images of the exterior indicating surroundings of the vehicle and generates image data. In other words, imaging circuit 20 is installed to image the surroundings of the vehicle. Specifically, imaging circuit 20 captures images, for example, of the rear space of vehicle 10, and captures exterior images showing the state of the rear space. Controller circuit 22 executes various types of data processing based on the image data generated by imaging circuit 20.

Image processor circuit 24 generates image data based on exterior image data. In this exemplary embodiment, image processor circuit 24 generates image data including a corrected image obtained by performing distortion correction on the exterior images. Image processor circuit 24 outputs the generated image data to output circuit 28. Note that image processor circuit 24 may output exterior images output from imaging circuit 20 as-is as image data to output circuit 28 without processing.

Detector circuit 26 detects various objects included in the exterior images by a known method such as pattern matching (in other words, template matching) or optical flow. In other words, detector circuit 26 detects an object present in a target space for imaging. The object to be detected may include a pedestrian, an obstacle, a car stop, a sign, and the like. Detector circuit 26 outputs detection information indicating a detected object, for example by indicating the name of the object identified by pattern matching to output circuit 28 and calibrator circuit 30.

Detector circuit 26 stores in advance a pattern of a first instruction image and a pattern of a second instruction image as patterns for pattern matching. The first instruction image is an image of a predetermined mode, and indicates an instruction of start of the calibration. The second instruction image is an image different from the first instruction image, is an image of a predetermined mode, and indicates an instruction for calibration termination. In this manner, the first instruction image and the second instruction image respectively function as first instruction information for instructing start of the calibration and second instruction information for instructing calibration termination. The first instruction image and the second instruction image may be a combination of a predetermined shape, pattern, and color. Also, the first instruction image and the second instruction image may be one-dimensional barcodes or two-dimensional barcodes. Detector circuit 26 detects whether or not the first instruction image is included in the exterior image data. When the first instruction image is included, that is detected by pattern matching. Also, detector circuit 26 detects whether or not the second instruction image is included in the exterior image data. When the second instruction image is included, that is detected by pattern matching.

Output circuit 28 outputs the image data received from image processor circuit 24 and the detection information received from detector circuit 26 to driving assistance device 14. Further, output circuit 28 outputs information indicating the operating condition of camera 12 to driving assistance device 14. This information is, for example, information indicating the calibration status. In other words, when calibrator circuit 30 starts the calibration process, output circuit 28 outputs the information indicating the calibration status outward.

When detector circuit 26 detects the first instruction image, in other words, when the detection information output from detector circuit 26 indicates a detected fact of the first instruction image, calibrator circuit 30 shifts camera 12 to a maintenance mode. In other words, calibrator circuit 30 starts the calibration process of camera 12. With the transition to the maintenance mode, calibrator circuit 30 activates a camera calibration program stored in advance. As a result, calibrator circuit 30 executes the automatic calibration process of camera 12 (for example, imaging circuit 20). A known technique may be employed as the automatic calibration process of camera 12, and for example, the technique described in Unexamined Japanese Patent Publication No. 2011-155687 may be applied.

Calibrator circuit 30 periodically outputs information indicating the calibration status to output circuit 28 during the calibration process of camera 12. Output circuit 28 outputs these items of information to driving assistance device 14. The information indicating the calibration status may include the progress status of the calibration process. Also, the information indicating the calibration status may include the ratio of the number of completed work items to the number of work items of the entire calibration process, and may include an estimated time until the calibration process ends.

When the second instruction image is detected by detector circuit 26, in other words, when the detection information output from detector circuit 26 indicates a fact of detection of the second instruction image, calibrator circuit 30 causes camera 12 to transition to the normal mode. When second instruction image is detected by detector circuit 26 while the calibration process of camera 12 is completed, calibrator circuit 30 shifts camera 12 to the normal mode. With the transition to the normal mode, calibrator circuit 30 terminates the camera calibration program. At the same time, calibrator circuit 30 outputs information indicating that the mode is the normal mode (or information that calibration of the camera has ended) to output circuit 28. Output circuit 28 sends this information to driving assistance device 14.

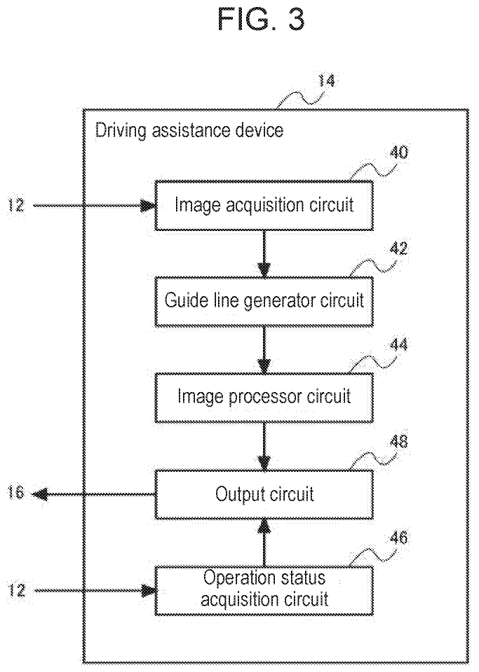

FIG. 3 is a block diagram showing a functional configuration of driving assistance device 14. Driving assistance device 14 has image acquisition circuit 40, guide line generator circuit 42, image processor circuit 44, operation status acquisition circuit 46, and output circuit 48. Image acquisition circuit 40 acquires image data and detection information output from camera 12.

Guide line generator circuit 42 generates data of the vehicle width guide line based on guide generation criteria stored in a storage unit (not illustrated). For example, guide line generator circuit 42 generates data of a vehicle width guide line having a range, a size, a shape, and a color defined by the guide generation criteria. The vehicle width guide line includes a vehicle width line indicating the vehicle width of vehicle 10 and/or a planned traveling trajectory line of vehicle 10.

Image processor circuit 44 generates parking assistance information based on a corrected image indicated by the image data acquired by image acquisition circuit 40, information such as obstacles indicated by the detection information acquired by image acquisition circuit 40, and a vehicle width guide line generated by guide line generator circuit 42. For example, image processor circuit 44 may generate a rear view image or a top view image, which is a composite image obtained by combining the corrected image, the image indicating obstacle and the like, and the vehicle width guide line, as the parking assistance information. Image processor circuit 44 outputs the generated parking assistance information to output circuit 48.

Operation status acquisition circuit 46 acquires information indicating the operating condition of camera 12 output from camera 12, and outputs the information to output circuit 48. Output circuit 48 outputs the parking assistance information output from image processor circuit 44 and the information indicating the operating condition of camera 12 output from operation status acquisition circuit 46 to display device 16. Display device 16 displays parking assistance information (for example, a rear view image) acquired from driving assistance device 14 and information indicating the operating condition of camera 12 on a screen.

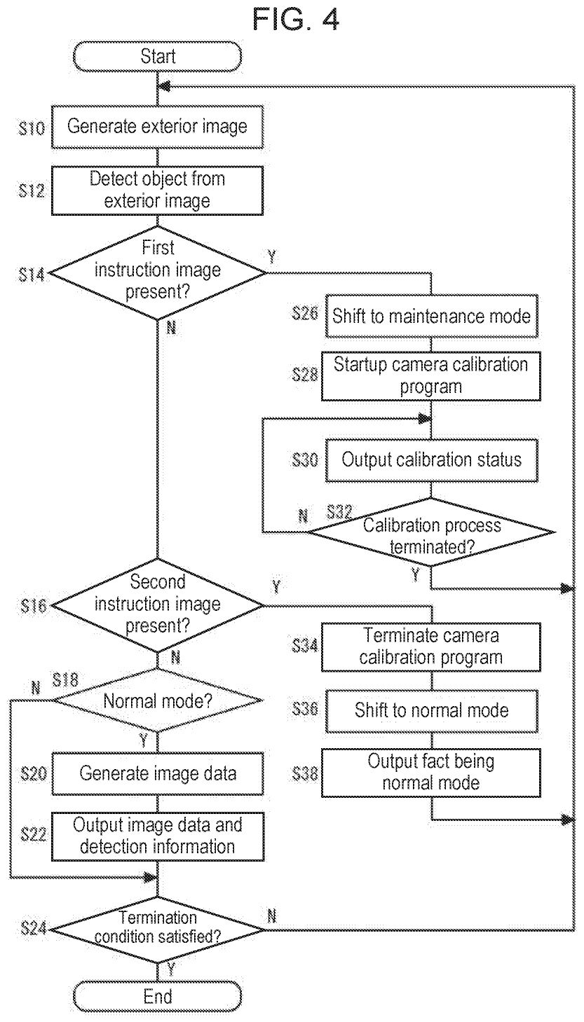

Next, an operation of camera 12 having the configuration described thus far will be described with reference to FIG. 4 as well. FIG. 4 is a flowchart showing the operation of camera 12. When the gear of vehicle 10 is set to reverse and when the process of FIG. 4 is started, imaging circuit 20 repeatedly generates exterior images showing the view of the rear space of vehicle 10 (S10). Detector circuit 26 detects an object present in the target space for imaging based on the exterior images (S12).

When there is no first instruction image (N in S14) and no second instruction image (N in S16) in the detected object, and camera 12 is in normal mode (Y in S18), image processor circuit 24 generates image data based on the exterior images (S20). Output circuit 28 outputs the image data generated by image processor circuit 24 and the detection information of the object generated by detector circuit 26 to driving assistance device 14 provided outside of camera 12 (S22). Driving assistance device 14 generates parking assistance information based on the information described above and causes display device 16 to display the parking assistance information. Note that output circuit 28 may output either image data or detection information of the object detected by detector circuit 26.

When camera 12 is not in the normal mode but in the maintenance mode (N at S18), the process skips S20 and S22. When the predetermined termination condition is satisfied (Y in S24), camera 12 terminates the process shown in FIG. 4. For example, when the gear of vehicle 10 is changed to some position other than reverse, or when a power source of vehicle 10 is turned off, camera 12 ends the process shown in FIG. 4. When the predetermined termination condition is not satisfied (N in S24), the process returns to S10.

Although not shown in FIG. 3, a maintenance worker holds the card or the like showing the first instruction image in front of camera 12 to start the calibration process of camera 12, for example, at the time of maintenance of camera 12 in a car dealership or the like. Further, for terminating the calibration process of camera 12, the maintenance worker holds a card or the like indicating a second instruction image in front of camera 12.

When detector circuit 26 detects the first instruction image (Y in S14), calibrator circuit 30 shifts camera 12 to the maintenance mode (S26), activates a predetermined camera calibration program, and starts the automatic calibration process (S28). Calibrator circuit 30 outputs a progress status of the calibration process to driving assistance device 14 via output circuit 28 (S30). Driving assistance device 14 outputs the progress status of the calibration process of camera 12 to display device 16 and causes display device 16 to display the progress status. The maintenance worker can check the progress status of the calibration process by looking at display device 16. When the calibration process is being executed (N in S32), the process returns to S30, and when the calibration process is completed (Y in S32), the process returns to S10.

When the second instruction image is detected by detector circuit 26 (Y in S16), calibrator circuit 30 ends the camera calibration program activated in S28 (S34), and shifts camera 12 to the normal mode (S36). Calibrator circuit 30 outputs the information indicating the normal mode or the information indicating that the camera calibration process has terminated to driving assistance device 14 through output circuit 28 (S38), and the process returns to S10. Driving assistance device 14 outputs the information to display device 16 and causes display device 16 to display the information. The maintenance worker can check display device 16 to confirm the termination of the calibration process.

According to camera 12 of this exemplary embodiment, it is not necessary to have a reception unit (reception function) for receiving an instruction from an external device to start the calibration process or to terminate the calibration process. Also, it is not necessary to have a different reception unit (reception function) for each specification of the external device (driving assistance device 14 or display device 16). This can reduce the development cost and the production cost of camera 12. Moreover, the versatility of manufacture of camera 12 can be improved.

Also, when camera 12 includes imaging circuit 20 that generates exterior images of a predetermined space and detector circuit 26 that detects the object present in a target space for imaging, a control unit incorporated in the camera may be caused to execute the automatic calibration process like in this exemplary embodiment by, for example, adding an application program (control program). For this reason, the versatility of manufacture of camera 12 can be improved.

Note that when detector circuit 26 detects an object that performs a predetermined first operation across a plurality of exterior images by optical flow, detector circuit 26 may detect an image of the object as the first instruction image. When detector circuit 26 detects an object that performs a predetermined second operation across a plurality of exterior images, detector circuit 26 may detect an image of the object as a second instruction image. In this case, a user can instruct the start and termination of the calibration process of camera 12 by predetermined gestures with body and hands.

In the above description, the first instruction image indicating the instruction of the start of the calibration and the second instruction image indicating the instruction of the termination of the calibration are detected. However, the present disclosure is not limited to these two instruction images. For example, as a third instruction image, an instruction image of another process such as a calibration stop instruction to interrupt the calibration process may be set and detected in the calibration process of camera 12. This improves the maintainability (operability) by the maintenance worker.

In this exemplary embodiment, camera 12 and driving assistance device 14 are separately configured, but camera 12 may be configured to incorporate driving assistance device 14. In this case as well, the same effect is achieved.

### Second Exemplary Embodiment

In second exemplary embodiment, information of a light flashing pattern (or blinking pattern) of light acquired from images captured in time series by camera 12 is used as predetermined instruction information instructing an activation of the camera calibration program. It differs from the first exemplary embodiment in this respect. In the present exemplary embodiment, the configurations of vehicle 10, camera 12, and driving assistance device 14 are the same as the configurations described with reference to FIGS. 1 to 3 in the first exemplary embodiment. Differences from the first exemplary embodiment will mainly be described below.

In this exemplary embodiment, a light-emitting device (or a light source) is flashed, and camera 12 detects a flashing pattern. The light-emitting device is a light source such as an incandescent bulb that does not flash during a normal use. In this exemplary embodiment, the instruction information that activates the camera calibration program of camera 12 is referred to as first instruction information. In addition, the instruction information that causes execution of the camera calibration program of camera 12 to terminate is referred to as second instruction information. In other words, the first instruction information instructs the start of the calibration and the second instruction information instructs the termination of the calibration. The first instruction information corresponds to the first instruction image in the first exemplary embodiment and the second instruction information corresponds to the second instruction image of the first exemplary embodiment.

Detector circuit 26 illustrated in FIG. 2 stores a pattern of the first instruction information and a pattern of the second instruction information as light flashing pattern data in advance. The pattern of the first instruction information and the pattern of the second instruction information are different from each other in light flashing pattern. For example, the pattern of the first instruction information and the pattern of the second instruction information are different from each other in flashing intervals and a number of times of flashing. The specific light flashing pattern will be described later.

Although not shown, a maintenance worker holds a flashlight in front of camera 12 and causes the flashlight to flash in the pattern of the predetermined first instruction information to start the calibration process of camera 12, for example, at the time of maintenance of camera 12 in a car dealership or the like. Further, for terminating the calibration process of camera 12, the maintenance worker holds the flashlight in front of camera 12 and causes the flashlight in a predetermined pattern of the second instruction information.

Detector circuit 26 detects the light flashing pattern from a plurality of exterior images in time series captured by imaging circuit 20. In addition, detector circuit 26 replaces presence or absence of brightness higher than or equal to a certain value at each pixel of the exterior images with a Hi/Lo signal, and specifies a pattern of Hi/Lo signals across the plurality of exterior images in time series. The pattern with the Hi/Lo signals includes pattern parts indicating specific signals and pattern parts indicating signal types.

Specifically, assuming that Hi=1 and Lo=0 are satisfied in Hi/Lo signals, the pattern of the first instruction information is, for example, “111000111000111000101100”, and the pattern of the second instruction information is “111000111000111000101111”. A front half portion of each pattern, “111000111000111000” indicates the specific signal, and is common to the pattern of the first instruction information and the pattern of the second instruction information. A rear half portion of the pattern of the first instruction information “101100” and a rear half of the pattern of the second instruction information “101111” indicate the type of the signals, and are patterns for specifying the first instruction information and the second instruction information. Detector circuit 26 determines whether or not the pattern of the Hi/Lo signals matches the pattern of the first instruction information or the pattern of the second instruction information. This allows detector circuit 26 to discriminate these patterns easily from a normal high-brightness video.

Note that the pattern of the first instruction information may be a pattern which specifies that the light flashing is repeated by M times (for example, M≥2) at first time intervals. The pattern of the second instruction information may be a pattern that specifies that the light flashing is repeated by N times (for example, N≥2 and N≠M) at second time intervals equal to or different from the first time intervals.

When detector circuit 26 detects that the light flashing pattern across the plurality of exterior images in time series matches the pattern of the first instruction information, detector circuit 26 notifies the fact that the first instruction information is detected to calibrator circuit 30. Likewise, when detector circuit 26 detects that the light flashing pattern across the plurality of exterior images in time series matches the pattern of the second instruction information, detector circuit 26 notifies the fact that the second instruction information is detected to calibrator circuit 30.

When detector circuit 26 detects the first instruction information, calibrator circuit 30 shifts camera 12 to the maintenance mode, and activates the camera calibration program. Likewise, when detector circuit 26 detects the second instruction information, calibrator circuit 30 terminates the camera calibration program and shifts camera 12 to the normal mode.

### Third Exemplary Embodiment

In a third exemplary embodiment, when predetermined instruction information that activates the camera calibration program is detected simultaneously with a reference marker used in the calibration process, the camera calibration program is activated. In other words, the camera calibration program is activated when the reference marker appears in the same image as the predetermined instruction information. It differs from the first exemplary embodiment in this respect. In the present exemplary embodiment, the configurations of vehicle 10, camera 12, and driving assistance device 14 are the same as the configurations described with reference to FIGS. 1 to 3 in the first exemplary embodiment. Differences from the first exemplary embodiment will mainly be described below.

Detector circuit 26 illustrated in FIG. 2 stores a pattern of the predetermined reference marker used in the calibration process as pattern data for pattern matching. The pattern of the reference marker is characteristic data relating to the appearance of the reference marker. Detector circuit 26 determines whether or not an image of the predetermined reference marker for the calibration process is included in images generated by imaging circuit 20. When the image of the reference marker is included, detector circuit 26 notifies the fact of the detection of the reference marker to calibrator circuit 30. The reference marker may be a black and white checkerboard pattern provided in a state of vertical surface such as a partition.

When the first instruction information is detected from the image captured by imaging circuit 20 and the reference marker is further detected from the same image, calibrator circuit 30 activates the camera calibration program and starts the calibration process. Calibrator circuit 30 starts the calibration process when the detection of the first instruction information and the detection of the reference marker are notified simultaneously from detector circuit 26, or when the difference in timing of notification of detection between the first instruction information and the reference marker is within a range that can be regarded as being simultaneous.

Note that calibrator circuit 30 may terminate the calibration process when the second instruction information is detected from the image captured by imaging circuit 20 and the reference marker is detected from the same image.

Note that calibrator circuit 30 may calibrate an installation error of camera 12 to vehicle 10 as the calibration process by using the reference marker.

### Fourth Exemplary Embodiment

In a fourth exemplary embodiment, imaging circuit 20 captures an image of an interior of a vehicle (for example, in the interior of a cabin). It differs from the first exemplary embodiment in this respect. Differences from the first exemplary embodiment will mainly be described below.

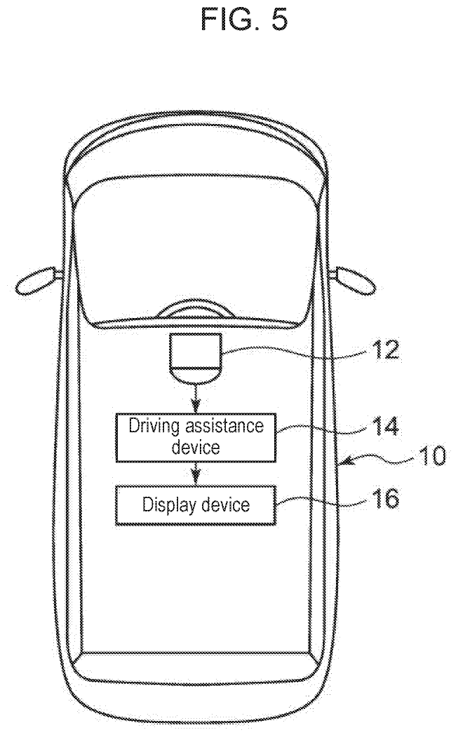

FIG. 5 schematically illustrates vehicle 10 according to the present exemplary embodiment. Vehicle 10 according to the present exemplary embodiment also includes camera 12, driving assistance device 14, and display device 16 like vehicle 10 of the first exemplary embodiment. However, camera 12 of vehicle 10 of the present exemplary embodiment is installed in the cabin, and captures images of the interior of the cabin.

In the present exemplary embodiment, the functional configurations of camera 12 is the same as the configuration described with reference to FIG. 2 in the first exemplary embodiment. Imaging circuit 20 of camera 12 generates images indicating the interior of the cabin of vehicle 10. Detector circuit 26 determines whether or not predetermined instruction information is included in images captured by imaging circuit 20. When the predetermined first instruction information is included, detector circuit 26 notifies the fact of the detection of the first instruction information to calibrator circuit 30. When detector circuit 26 detects the first instruction information, calibrator circuit 30 activates the camera calibration program and starts the calibration process.

In this exemplary embodiment, camera 12 is an in-vehicle camera for driver monitoring, that is, for detecting a view line, the facial expression, presence or absence of being caught asleep of the driver. In addition, a seat set to a predetermined state in terms of a fore-and-aft position, a reclining angle, and the like is used as the reference marker in the calibration process of camera 12. For example, an outer frame of a seatback of a seat, or an outer frame of a head rest is used as the reference marker.

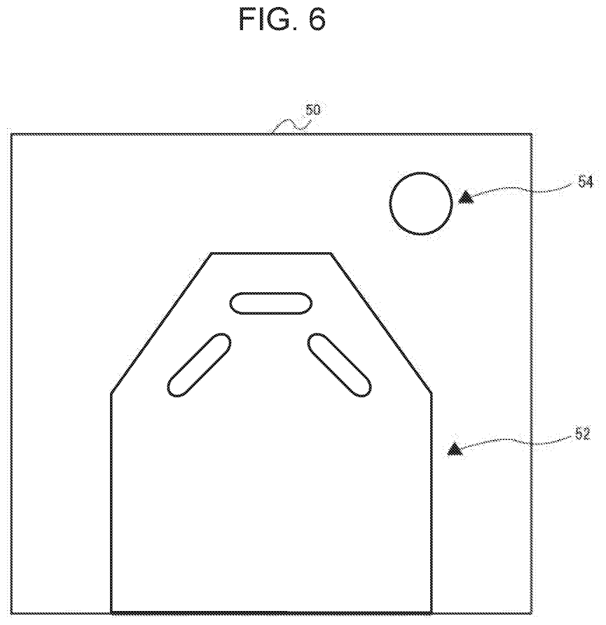

FIG. 6 illustrates an example of an image of the interior of the cabin generated by camera 12 according to the present exemplary embodiment. Cabin image 50 includes an image of reference markers 52 (driver's seats in this specification) and an image of instruction information 54. Reference marker 52 is an image of the driver's seat in this specification. Instruction information 54 is a light source that repeats light flashing as described in conjunction with the second exemplary embodiment.

As described in the third exemplary embodiment, detector circuit 26 detects a presence of reference marker 52 and a presence of instruction information 54 from cabin image 50. Calibrator circuit 30 starts the calibration process when both of reference marker 52 and instruction information 54 are detected from cabin image 50. For example, calibrator circuit 30 extracts an outline, a shape, a pattern, and the like of reference marker 52 from the image of the driver's seat, which corresponds to reference marker 52 with reference to cabin image 50, and calculates calibration coordinate based on the extracted outline or the like.

In the present exemplary embodiment as well, detector circuit 26 may detects the second instruction information indicating the termination of the calibration, when the second instruction information is included in cabin image 50. When detector circuit 26 detects the second instruction information, calibrator circuit 30 terminates the camera calibration program.

Note that detector circuit 26 may detect an image of the seat set in fore-and-aft position and reclining angle to a predetermined first state, which appears in cabin image 50, as the first instruction information indicating the instruction of the start of the calibration. Likewise, detector circuit 26 may detect an image of a seat set in fore-and-aft position and reclining angle to a predetermined second state, which appears in cabin image 50 and is different from the first state, as the second instruction information indicating the instruction of the termination of the calibration. In other words, in this state, detector circuit 26 detects the predetermined first instruction image and second instruction image respectively as the first instruction information and second instruction information. Alternatively, two types of flashing patterns of the light source, which repeats light flashing, may be detected respectively as the first instruction information and the second instruction information.

### Fifth Exemplary Embodiment

A fifth exemplary embodiment is similar to the first exemplary embodiment in configurations of vehicle 10, camera 12, driving assistance device 14, but is different from the first exemplary embodiment in part of operation of camera 12. Differences from the first exemplary embodiment will mainly be described below.

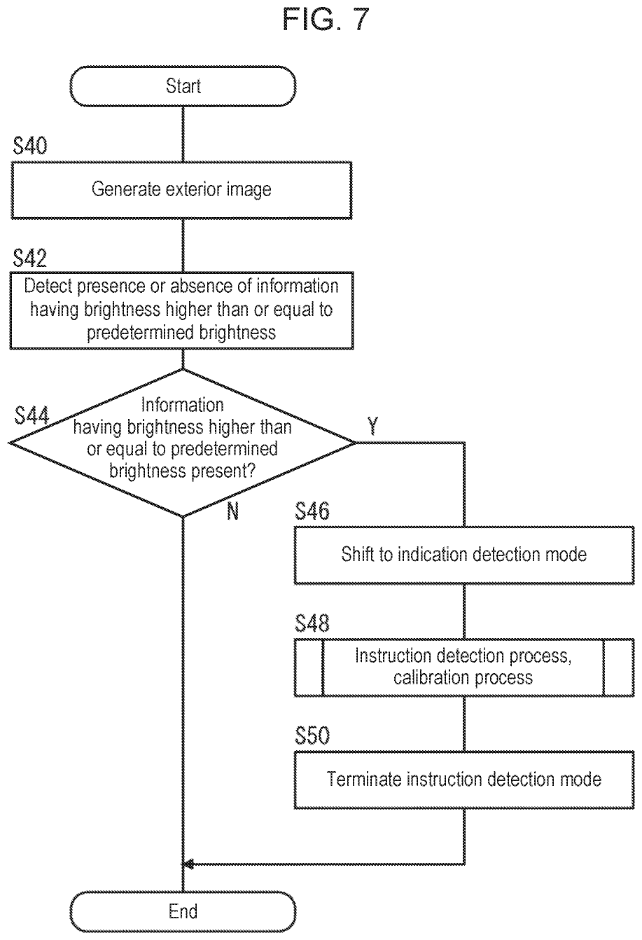

FIG. 7 is a flowchart showing a behavior of camera 12 of this exemplary embodiment. Imaging circuit 20 repeatedly generates exterior image data (S40). For example, imaging circuit 20 outputs brightness image (gray scale image and the like) indicating brightness values of an object to be imaged. Detector circuit 26 detects whether or not data having a brightness higher than or equal to a predetermined brightness is present in the exterior image data (S42). In other words, when a brightness value higher than or equal to a predetermined threshold is present in the brightness image output from imaging circuit 20, detector circuit 26 determines that the information having a brightness value higher than or equal to the predetermined threshold is present. An adequate value of the threshold value of the brightness may be determined by knowledge of developer or an experiment using camera 12.

When data having a brightness higher than or equal to the predetermined brightness is present in the exterior image data (Y in S44), detector circuit 26 is shifted to the instruction detection mode (S46). From then onward, the instruction detection process and the calibration process described in the first exemplary embodiment are executed (S48). More specifically, processes from S12 to S38 of the flowchart in FIG. 4 are executed. When the calibration process by calibrator circuit 30 is terminated, detector circuit 26 terminates the instruction detection mode (S50), and the flow is ended. When no data having a brightness higher than or equal to the predetermined brightness is present in the exterior image data (N in S44), the process of S46 to S50 are skipped and the flow is ended. Actually, the procedure returns to S40, and the process of determining the presence or absence of data having a brightness higher than or equal to the predetermined brightness in the newly generated exterior image data is repeated.

With this control, when new exterior image data is generated, the process of determining whether or not the instruction information is present in the exterior images (pattern matching or the like) is skipped when the exterior images do not include data having a brightness value higher than or equal to the predetermined brightness value. This enables a reduction of the load of image processing in camera 12. Note that a combination of the fourth exemplary embodiment and the fifth exemplary embodiment is also possible. In other words, when imaging circuit 20 captures images in the cabin, not the exterior, detector circuit 26 may switch the operation between executing and not executing the instruction detection process depending on whether or not data having a brightness value higher than or equal to the predetermined brightness value is present in the cabin image data.

The present disclosure has been described above according to the first to the fifth exemplary embodiments. It will be understood by those skilled in the art that these exemplary embodiments are merely examples, other modifications in which components and/or processes of the exemplary embodiments are variously combined are possible, and the other modifications are still fall within the scope of the present disclosure.

Techniques disclosed in the exemplary embodiments and the modifications may be identified by the following items.

[Item 1]

An in-vehicle camera installed in a vehicle includes an imaging circuit, a detector circuit, and a calibrator circuit. The imaging circuit generates image data. The detector circuit stores predetermined first instruction information and detects whether the image data generated by the imaging circuit includes the first instruction information. When the detector circuit detects that the image data includes the first instruction information, the calibrator circuit starts a calibration process of the in-vehicle camera.

In this configuration, the calibration process is automatically executed according to information (object or the like) indicating the instruction of start of the calibration present in a target space to be imaged by the imaging circuit. This eliminates the necessity of provision of a reception unit that receives an instruction of the start of the calibration from an external apparatus (HMI apparatus or the like) in the in-vehicle camera, and reduces the cost of the in-vehicle camera.

[Item 2] The imaging circuit may be installed to capture images of surroundings of the vehicle. In this case, images, objects, and the like present outside the vehicle may be included in the first instruction information.

[Item 3]

The detector circuit is further capable of detecting objects present in the surroundings of the vehicle, and the in-vehicle camera may further include an output circuit that outputs at least one of the image data and the detection information of the object detected by the detector circuit outward. In this configuration, information (data) output from the output circuit can be used for driving assistance such as collision avoidance. In other words, the camera installed for the driving assistance or the like can be used as an imaging circuit in parallel.

[Item 4]

The output circuit may output the information indicating the calibration status outward when the calibrator circuit starts the calibration process. In this configuration, for example, estimated time until the termination of the calibration process (maintenance) may be figured out, and thus improved convenience is achieved.

[Item 5]

The imaging circuit may be installed to capture images of the interior of the vehicle. In this configuration, the calibration process can be started automatically according to the instruction information present in the interior of the vehicle (in the cabin or the like).

[Item 6]

The detector circuit may detect a predetermined instruction image as the first instruction information. For example, one-dimensional barcodes or two-dimensional barcodes may be used as the instruction image. This allows calibration to be started by a specific, but simple configuration, such as by using a card or the like.

[Item 7]

The detector circuit may detect a light flashing pattern as the first instruction information. In this configuration, the calibration process can be started automatically even without any specific image for instructing the start of the calibration, by utilizing a general light-emitting device and using a flashing pattern of light emitted from the light-emitting device as a signal.

[Item 8]

The detector circuit may be further capable of detecting whether or not a reference marker is included in the image data, and the calibrator circuit may start the calibration process when the detector circuit detects that the reference marker is included in the image data in addition to the first instruction information. In this manner, by utilizing both of the first instruction information and the reference marker as conditions of starting the calibration process, erroneous start of the calibration process can be suppressed. In addition, since the fact that images of the reference marker can be captured by an imaging circuit is ensured, execution of the calibration process is ensured.

[Item 9]

The calibrator circuit may calibrate an installation error of the in-vehicle camera to a vehicle as the calibration process by using the reference marker.

[Item 10] The detector circuit may be capable of storing predetermined second instruction information and further detecting whether the image data includes the second instruction information. In this case, when the detector circuit detects that the image data includes the second instruction information, the calibrator circuit may terminate the calibration process of the in-vehicle camera. In this configuration, the calibration program can be terminated in the same manner as in the case of the start of the calibration without providing a reception unit.

Any desired combinations of the above described exemplary embodiments and the above described modifications are also useful as other exemplary embodiments of the present disclosure. Any new exemplary embodiments formed by such combinations include benefits of the exemplary embodiments and the modifications combined into the new exemplary embodiments. It will be understood by those skilled in the art that functions that should be carried out by constituent elements described in the appended claims can be achieved by each of or through cooperation of the constituent elements illustrated in the exemplary embodiments and the modifications.

According to the present disclosure, calibration of the in-vehicle camera can be started with a simple configuration. Therefore, the reception unit for receiving instructions from the display device does not have to be provided. This in-vehicle camera is applicable to various vehicles.

What is claimed is:

1. An in-vehicle camera to be installed in a vehicle, the in-vehicle camera comprising:
an imaging circuit configured to generate image data;
a detector circuit configured to store a predetermined first instruction information and detect whether or not the image data includes the first instruction information; and
a calibrator circuit configured to start a calibration process of the in-vehicle camera when the detector circuit detects that the image data includes the first instruction information.

2. The in-vehicle camera according to claim 1, wherein the imaging circuit is installed to capture an image of surroundings of the vehicle.

3. The in-vehicle camera according to claim 2, wherein the detector circuit is further capable of detecting an object present in the surroundings of the vehicle, and
the in-vehicle camera further includes an output circuit configured to output at least one of the image data and detection information of the object detected by the detector circuit outward.

4. The in-vehicle camera according to claim 3, wherein the output circuit outputs information indicating a calibration status outward when the calibrator circuit starts the calibration process.

5. The in-vehicle camera according to claim 1, wherein the imaging circuit is installed to capture an image of an interior of the vehicle.

6. The in-vehicle camera according to claim 1, wherein the detector circuit detects a predetermined instruction image as the first instruction information.

7. The in-vehicle camera according to claim 1, wherein the detector circuit detects a light flashing pattern as the first instruction information.

8. The in-vehicle camera according to claim 1, wherein the detector circuit is further capable of detecting whether or not a reference marker is included in the image data, and
the calibrator circuit starts the calibration process of the in-vehicle camera when the detector circuit detects that the reference marker is included in the image data in addition to the first instruction information.

9. The in-vehicle camera according to claim 8, wherein the calibrator circuit calibrates an installation error of the in-vehicle camera on the vehicle by using the reference marker as the calibration process.

10. The in-vehicle camera according to claim 1, wherein the detector circuit is capable of storing predetermined second instruction information and further detecting whether the image data includes the second instruction information, and
the calibrator circuit terminates the calibration process of the in-vehicle camera when the detector circuit detects that the image data includes the second instruction information.
